(19) United States
(12) Patent Application Publication
(10) Pub. No.: US 2019/0065477 A1
(43) Pub. Date: Feb. 28, 2019

(54) Method of extracting text in text layer, method of providing translated webcomic, and computer device for performing the same

(71) Applicants: KOREA DATA HOUSE CO., LTD., Seoul (KR); KOREA ELECTRONICS TECHNOLOGY INSTITUTE, Seongnam-si (KR)

(72) Inventors: Hong-Seon Hwang, Seoul (KR); Yeon-Kug Moon, Hanam-si (KR); Hee-Hwa Yun, Seoul (KR)

(21) Appl. No.: 15/690,456

(22) Filed: Aug. 30, 2017

(30) Foreign Application Priority Data
Aug. 22, 2017 (KR) 10-2017-0106001

(51) Int. Cl. G06F 17/28; G06F 17/21; G06F 17/27; G06F 17/22

(52) U.S. Cl. CPC G06F 17/289; G06F 17/218; G06T 11/60; G06F 17/2745; G06F 17/2247; G06F 17/2705

(57) ABSTRACT

Disclosed is a method of extracting text in a text layer, method of providing a translated webcomic, and computer device for performing the same. The present invention can determine whether a PSD file is a text layer by parsing a layer and mask information section, parsing additional layer information in the layer and mask information, reading a ‘Key’ having length of 4, and determining whether the ‘Key is composed of a ‘TySh’ tag. According to a method of extracting text in a text layer, method of providing a translated webcomic, and computer device for performing the same of the present invention, the text in the text layer of a webcomic can be entirely extracted without being truncated.

### CROSS REFERENCE TO RELATED APPLICATION

This application claims the priority benefit of Korean Patent Application No. 10-2017-0106001, filed on Aug. 22, 2017 in the Korean Intellectual Property Office, the disclosure of which is incorporated herein by reference

### BACKGROUND OF THE INVENTION

### Field of the Invention

The present invention relates generally to a method of extracting text in a text layer, method of providing a translated webcomic, and computer device for performing the same. More particularly, the present invention relates to a method of extracting text in a text layer by layer editing of a layered image file format, a method of providing a translated webcomic, and computer device for performing the same.

### Description of the Related Art

Comics originally meant paintings on thick paper, i.e. strawboard or cardboard, but today commonly mean comics in one cut. A webcomic is a neologism made up of ‘web’ stands for a website and ‘comics’. The webcomic has been used both as a term for web animation formed in Adobe Flash and a term for all comic formats formed on the web. However, the term webcomic is now used to refer to comics that are formed in a dimensionally long image file format and published on a website.

The Korean comic market had undergone stagnation in the past, but now faces new period of prosperity. Webcomics, which are currently the most popular comics, are gaining popularity with an average of 6.2 million readers per day. Secondary contents e.g. publications, soap operas, movies, etc. reproduced based on webcomics lead the domestic culture market. Particularly, the webcomic is new growth engine business creating infinite added value, and is called a blue chip industry. There have been some webcomics successful in overseas market.

In order to earn profit from the new growth engine business, it is necessary to enter overseas markets without being limited to the domestic market, and translation is essential to enter overseas markets. However, except for popular writers, most small webcomic writers are unable to afford translation requiring considerable time and costs, and thus it is realistically difficult for various webcomics to enter overseas market.

Adobe Photoshop is used in coloring and editing webcomics. After coloring and editing, onomatopoeia and dialogue are inserted, webcomics are resized for web resolutions, and the format thereof is transformed, whereby webcomics are completed. Since webcomics are processed by using Adobe Photoshop, the original webcomics are stored and managed as Photoshop Document (PSD) files. However, the format is transformed into JPEG for the web. In this process, all pieces of information such as layers, channels, etc. in the PSD file, which is the original webcomic, are merged into one image format.

In JPEG format as one of image formats, layers, channels, etc. cannot be separated from the original. For animation (movement) of a particular object in the webcomic, it is required to separate the particular object in the JPEG file by using Adobe Photoshop. Also, for translation of the dialogue, etc., it is required to open the JPEG file in Adobe Photoshop, to delete the dialogue in the speech balloons, and to insert the translated dialogue.

The PSD file being stored as the original webcomic contains information on objects and dialogues in respective layers and channels. Therefore, when it is possible to extract and store required information in the original PSD file and to modify and manage the information before transforming the webcomic in JPEG format, the steps of processing the JPEG file may be reduced, various processes (translation, multimedia process application, etc.) may be automatically performed simultaneously through analysis and datafication of information of the original webcomic.

However, in a case of a conventional “Java PSD parser lib”, when parsing the layer and mask information section of the PSD file format, a text layer, an image layer, etc. are parsed as an image binary file and thus, the image and text of the webcomic cannot be distinguished. Particularly, in an existing library format, there is a limitation in that the dialogue of the webcomic cannot be separated and content of the text cannot be extracted.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a method of extracting text of a text layer in a layered image file format without loss and translating the text, method of providing a translated webcomic, and computer device for performing the same.

In order to achieve the above object, there is provided a method of extracting text in a text layer from a Photoshop file containing an image layer and the text layer, the method including: uploading the Photoshop file at a first step; parsing, at a second step, a layer and mask information section and parsing additional layer information of the layer and mask information section, reading a ‘Key’ having length of 4, and determining whether the ‘Key’ is composed of a ‘TySh’ tag; and determining, at a third step, a relevant layer as the text layer when determining that the ‘Key’ is composed of the ‘TySh’ tag at the second step.

In order to achieve the above object, there is provided a method of providing a translated webcomic by translating text of a text layer in an original language into another language, the webcomic containing one episode composed of several image layers and several text layers as scripts, the method including: uploading a Photoshop file at a first step; parsing, at a second step, a layer and mask information section and parsing additional layer information of the layer and mask information section, reading a ‘Key’ having length of 4, and determining whether the ‘Key is composed of a ‘TySh’ tag; determining, at a third step, a relevant layer as the text layer when determining that the ‘Key’ is composed of the ‘TySh’ tag at the second step and extracting the text in the text layer and a text attribute including a font color; providing, at a fourth step, a translation tool showing both the text layer including the text in an original language and a text input window for inputting text to be translated; performing, at a fifth step, machine translation of the text in the original language to provide the machine-translated text to the text input window, and receiving error corrections of the machine-translated text; and transforming, at a sixth step, the text attributes of the machine-translated text at the fifth step to generate a Photoshop file, and providing a translated webcomic file by using the Photoshop file.

In order to achieve the above object, there is provided a computer device including a memory having a program for extracting text in a text layer from a Photoshop file containing an image layer and the text layer, the program executing a series of processes including: uploading the Photoshop file at a first step; parsing, at a second step, a layer and mask information section and parsing additional layer information of the layer and mask information section, reading a ‘Key’ having length of 4, and determining whether the ‘Key’ is composed of a ‘TySh’ tag; and determining, at a third step, a relevant layer as the text layer when determining that the ‘Key’ is composed of the ‘TySh’ tag at the second step.

According to the method of extracting text in a text layer, the method of providing a translated webcomic, and the computer device for performing the same, the text in the text layer of a webcomic can be entirely extracted without being truncated.

Also, according to the method of extracting text in a text layer, the method of providing a translated webcomic, and the computer device for performing the same, several users in cloud environments can translate the text of a webcomic, whereby translation quality of the webcomic can be enhanced.

That is, according to the method of extracting text in a text layer, the method of providing a translated webcomic, and the computer device for performing the same, the translated text can be displayed on a text input window and can be modified such that time and costs for translation can be significantly reduced, compared to that required for a translator who translates the text from beginning to end.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a flowchart showing an overall process of translating a text layer of a webcomic in a layered image file format according to an embodiment of the present invention;

FIG. 2 is a view showing an example of code for parsing a file header section;

FIG. 3 is a view showing an example of code for mapping text data and attribute in Java language;

FIG. 4 is a view showing an example of code for storing extracted text data in HawText object;

FIG. 5 is a view showing a structure in a database to which content extracted from a text layer is uploaded; and

FIG. 6 is a view showing an example of an execution screen of a text transform UI where several PSD files of one episode are arranged in order and a text input window matched with a speech balloon in a text layer at the right side.

### DETAILED DESCRIPTION OF THE INVENTION

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations thereof but do not preclude the presence or addition of one or more other features, integers, steps, operations, elements, components, and/or combinations thereof.

Also, in the specification, “on or at an upper portion of” means positioning above or below an object portion, but does not essentially mean positioning on the upper side of the object portion based on a gravity direction. Further, when a first element such as a region, a plate, etc. is referred to as being “on or at an upper portion of” a second element, the first element may be directly in contact with “the top or the upper portion of” the second element, or may be provided above the second element, having a space or the other element intervening therebetween.

Also, in the specification, it should be understood that when one element is referred to as being “connected to” or “coupled to” another element, it may be connected directly to or coupled directly to another element or be connected to or coupled to another element, having the other element intervening therebetween, unless there is another opposite description thereto.

Also, although the terms “first”, “second”, etc. may be used herein to describe various elements, these elements should not be limited by these terms. These terms are only used to distinguish one element from another element.

Generally, a webcomic is composed of a plurality of seasons published in series rather than a short story composed of one season. Each season is composed of a plurality of episodes, and each episode is composed of a plurality of scripts. Each script is constructed in one layered image file format. Generally, an image file format is composed of one or several image layers and one text layer. In special cases, one layered image file format may include several text layers.

As an example of the layered image file format, there is a PSD file format which is an image file format used in Adobe Photoshop. The PSD file format is a basic format used to store data in Photoshop, and is a format of a file where an individual layer can be processed.

The present invention is directed to webcomics in a layered image file format.

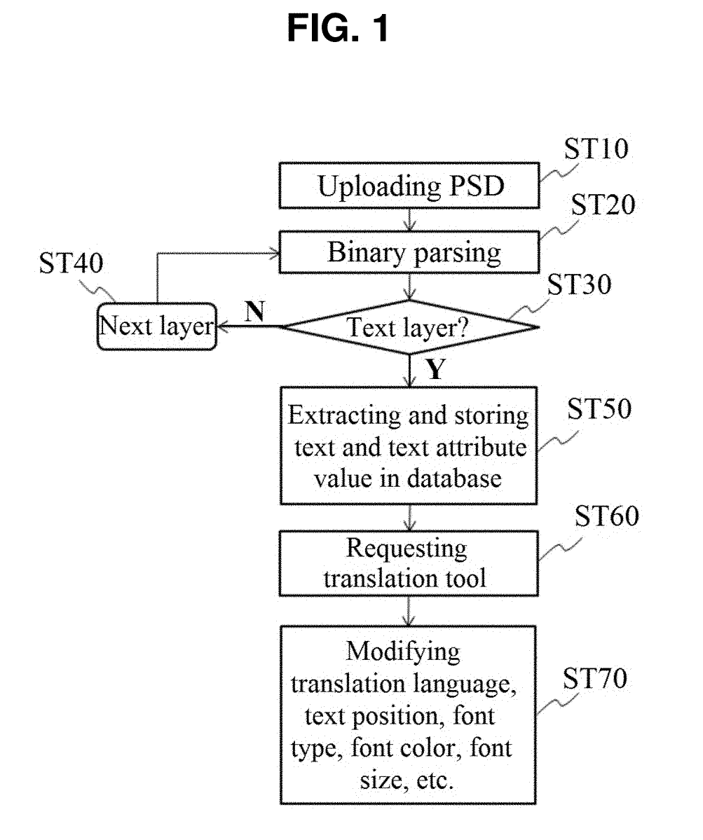

FIG. 1 is a flowchart showing an overall process of translating a text layer of a webcomic in a layered image file format according to an embodiment of the present invention.

A PSD file which is a layered image file is uploaded at ST 10 and is binary parsed at ST 20. The PSD file is composed of different layers. Whether or not a current layer is a text layer is determined at ST 30. When the current layer is not a text layer, a subsequent layer is parsed at ST 40 without further processes for the current layer.

When determined as a text layer, text and text attribute value (font, size, color, etc.) are extracted and stored in the database at ST 50. Next, a translation tool is requested to translate the text at ST 60. The translation tool performs primary translation through machine translation, and for accurate translation, secondary translation is manually performed by a translator to increase accuracy of translation. Next, the translated text is modified according to the attribute value of the original webcomic text, and the layer is completed to provide the translated text in the original text position at ST 70, whereby translation is finally completed.

PSD File Structure

A PSD file is in a binary format. Therefore, the PSD file is read in a binary format, and then the file is parsed to extract values according to particular rules.

Fundamentally, the PSD file structure is composed of five sections, i.e. file header, color mode data, image resources, layer and mask information, and image data.

File header section: is a section containing basic information of a Photoshop file as follows: Photoshop version information, the total image size, channel information, etc.

Color mode data section: is a section containing color mode information.

Image resources section: is a section containing information about image resources. The image resources section stores detailed information about resources, and provides detailed information about 89 characteristics such as resource information, background color, size unit, etc. In the image resources section, resolution information is extracted.

Layer and mask information section: is a section containing information about layers and masks. The layer and mask information section provides individual information for each layer, and provides general information about size, position, color, etc. and additional information. The additional information contains information about layer ID, layer name, effect, pattern, type tool, gradient, etc., and particularly, the type tool provides information about the text layer.

Image data section: is a section containing information about in which format the image data is stored. For example, based on values in formats such as 0=Raw Image Data, 1=RLE Compressed, 2=ZIP, whether an image is compressed may be determined.

Binary Parsing

In order to basically extract data provided by Photoshop, it is required to read the PSD file as binary formats and then, parse the PSD file.

Adobe Photoshop file specification provides definition of each section. For example, the file header section is defined by length and description as shown in table 1.

TABLE 1

| Length | Description |
|---|---|
| 4 | Signature: always equal to ‘8BPS’. Do not try to read the file if |
| | the signature does not match this value. |
| 2 | Version: always equal to 1. Do not try to read the file if the |
| | version does not match this value. (**PSB** version is 2.) |
| 6 | Reserved: must be zero. |
| 2 | The number of channels in the image, including any alpha |
| | channels. Supported range is 1 to 56. |
| 4 | The height of the image in pixels. Supported range is 1 to |
| | 30,000. (**PSB** max of 300,000) |
| 4 | The width of the image in pixels. Supported range is 1 to |
| | 30,000. (**PSB** max of 300,000) |
| 2 | Depth: the number of bits per channel. Supported values are |
| | 1, 8, 16 and 32. |
| 2 | The color mode of the file. Supported values are: Bitmap = 0; |
| | Grayscale = 1; Indexed = 2; RGB = 3; CMYK = 4; |
| | Multichannel = 7; Duotone = 8; Lab = 9. |

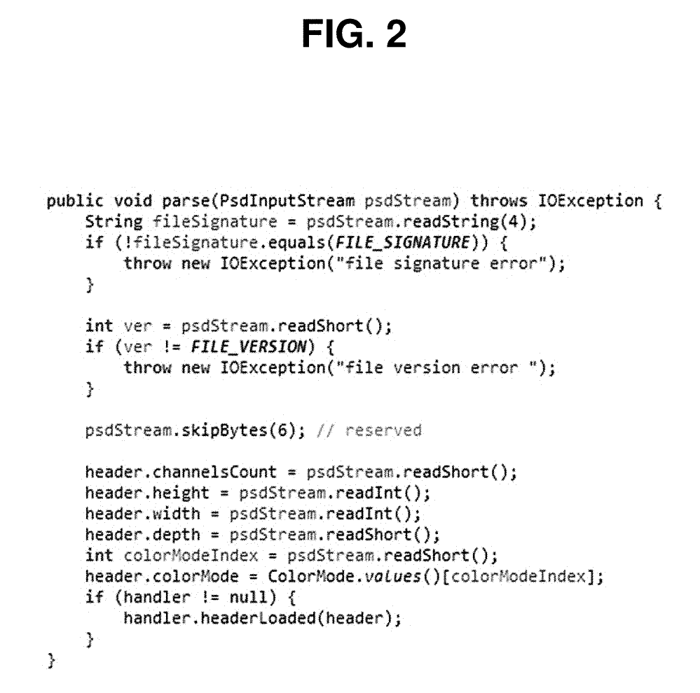

Accordingly, in the source, parsing process is executed according to the type of the length. Code for parsing the file header section is shown in FIG. 2.

TABLE 2

| Length | Description |
|---|---|
| 4 | Length of the layer and mask information section. (““PSB””” |
| | length is 8 bytes.) |
| Variable | Layer info (see See Layer info for details). |
| Variable | Global layer mask info (see See Global layer mask info for |
| | details). |
| Variable | Series of tagged blocks containing various types of data. See |
| | See Additional Layer Information for the list of the types of |
| | data that can be included here. |

Parsing of the layer and mask information section is performed in the similar manner. By parsing the additional layer information of the layer and mask information section, whether the layer is an image layer or a text layer is determined. Specifically, in the additional layer information of the layer and mask information section, information about layer ID, layer name, effect, pattern, type tool, gradient, etc. is extracted. In order to distinguish the text layer and the image layer, in the additional layer information, a ‘Key’ having length of 4 is read. When the ‘Key’ is composed of a ‘TySh’ tag, the relevant layer is determined as a text layer and desired data is extracted by parsing information.

TABLE 3

| Length | Description |
|---|---|
| 4 | Signature: ‘8BIM’ or ‘8B64’ |
| 4 | Key: a 4-character code (See individual sections) |
| 4 | Length data below, rounded up to an even byte count. |
| | (**PSB**, the following keys have a length count of 8 bytes: |
| | LMsk, Lr16, Lr32, Layr, Mt16, Mt32, Mtrn, Alph, FMsk, |
| | lnk2, FEid, FXid, PxSD. |
| Variable | Data (See individual sections) |

Text Data Extraction

In the additional layer information, the ‘Key’ having length of 4 is read, and when the ‘Key’ is determined as a ‘TySh’ tag, text data may be extracted through information about the text layer provided by the type tool. Specifically, as described above, when the ‘TySh’ tag is identified in the additional layer information and information is parsed according to the type tool object setting as follows, a part where the length is ‘Variable’ and the description is ‘Text data’ can be found as shown in table 4, and actual text is obtained therefrom.

TABLE 4

| Length | Description |
|---|---|
| 2 | Version (=1 for Photoshop 6.0) |
| 6 * 8 | Transform: xx, xy, yx, yy, tx, and ty respectively. |
| 2 | Text version (= 50 for Photoshop 6.0) |
| 4 | Descriptor version (= 16 for Photoshop 6.0) |
| Variable | Text data (see See Descriptor structure) |
| 2 | Warp version (= 1 for Photoshop 6.0) |
| 4 | Descriptor version (= 16 for Photoshop 6.0) |
| Variable | Warp data (see See Descriptor structure) |
| 4 * 8 | left, top, right, bottom respectively. |

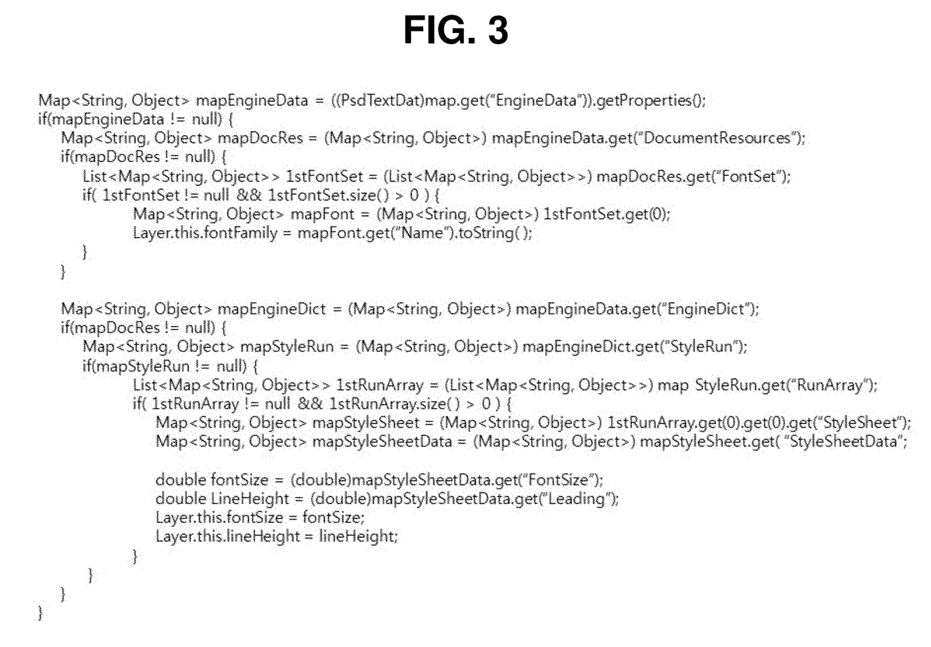

Next, the extracted text data is mapped in Java language as shown in an example of code in FIG. 3. FIG. 3 is a view showing an example of code for mapping text data and attributes in Java language. In a case of a layer, X, Y, width, and height values are extracted. In a case of a text layer, text, font, and font size attribute values are extracted in addition to the results of the image layer. Data obtained by mapping the text data in Java language according to the code shown in FIG. 3 is described as follows.

—Follows—

Txt: text content

Engine Data: font attribute value set

Document Resources: defined resource set

Engine Dict: applied resource set

Font Set: font

Font Size: font size

Leading: Line Height

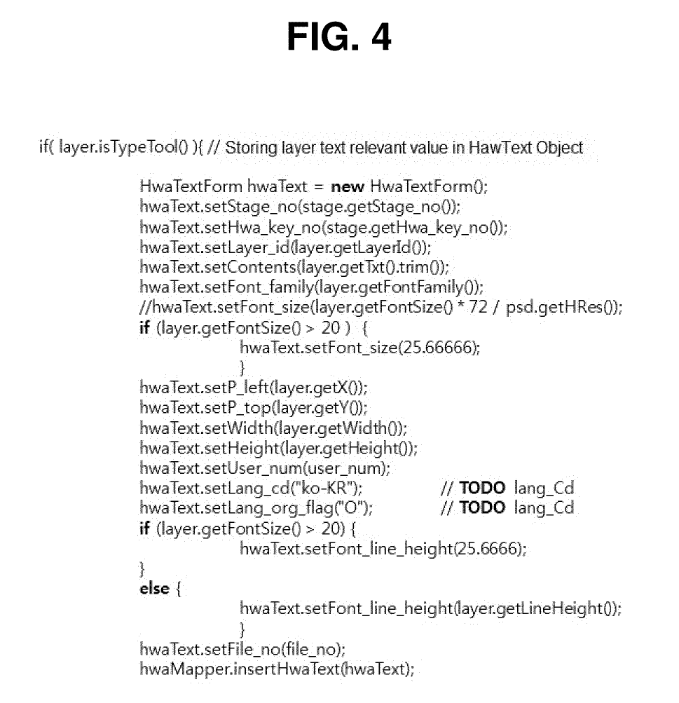

The extracted text data is stored in a particular object as shown in the code of FIG. 4, and is stored in the database. FIG. 4 is a view showing an example of code for storing the extracted text data in HawText object. After the process shown in FIG. 4, data stored in the database may be exposed on a writing screen or may be utilized as translation API. Some variables in FIG. 4 are described as follows.

—Follows—

hwaText=>text

setStage=>stage having text

setHwa_key_no=>text unique key

setLayer_id=>layer ID

setContents=>text information (txt)

setFont_family=>font family value of text (Times New Roman, etc.)

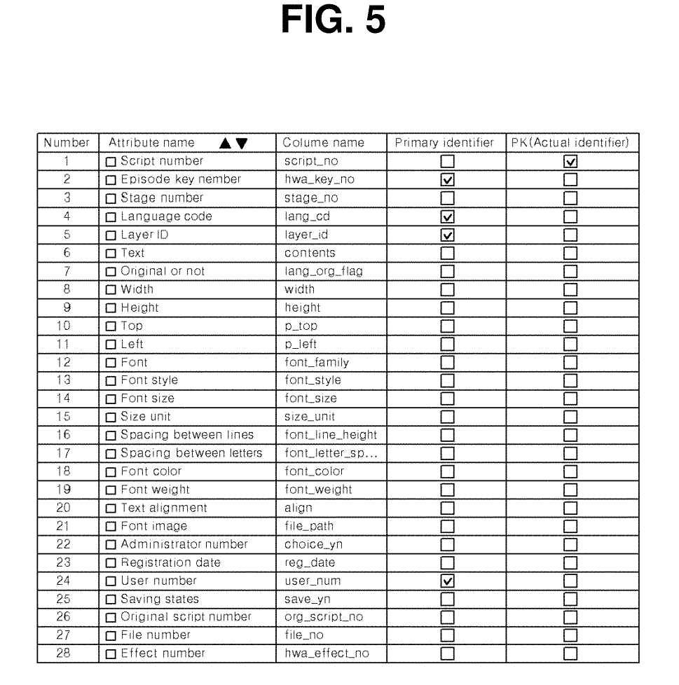

FIG. 5 is a view showing a structure in a database to which content extracted from a text layer is uploaded. All text layers have script no numbers as unique keys. All text is distinguished based thereon. Also, in order to distinguish which PSD file of which episode, an episode unique number (hwa_key_no) and a stage unique number (stage_no) are used. The original language is stored by setting a language code that is set when generating an episode as the default value. In storing a primary attribute value in a database, the primary attribute value is stored as being in formats to be compatible with a primary attribute value of cascading style sheets (CSS) since the extracted content is required to be shown on the web.

The contents are actual text. The width, height, p_top, and p_left are respectively width, height, top position, and left position values, and the unit of each value is pixel (px). The font_family is a font, and has a string value. The font_style is a font style value, and has a detailed attribute value for italic, and bold. The font_size is a font size, and uses a point (pt) as a unit. The font_line_height is spacing between lines, the font_letter_space is spacing between letters, the font_color is a font color, and the font_weight is a font weight.

Method of Matching Text Speech Balloon Position Values in Webcomics

One episode is composed of several PSD files. XY coordinates, attribute values of the font, etc. of the text layer stored in the database are shown as webcomics to users.

All text layers have script no numbers as unique keys. All texts are distinguished based thereon. Also, in order to distinguish which PSD file of which episode, an episode unique number (hwa_key_no) and a stage unique number (stage_no) are used. The original language is stored by setting a language code that is set when generating an episode as the default value.

Text Transform UI (Translation Tool)

One episode of the webcomic is composed of several images (PSDs) in a longitudinal direction. Each image has unique stage_no, and images are arranged in order. Based on each hwa_key_no, the text layer is arranged according to X, Y coordinates (p_left, p_top). The text layers have a unique script_no, and based thereon, the text layers are matched with text input windows of the translation tool. That is, the speech balloon shown in the left side of the translation tool and the text input window receiving the translated text shown in the right side of the translation tool are matched with each other based on an episode identifier (episode_no) for the episode, a script identifier (stage_no) for a script, and X, Y coordinates of the speech balloon in the script. Each speech balloon is stored in a text DB based on the episode identifier (episode_no), the script identifier (stage_no) for the script, and the serial number (hwa_key_no) assigned in the corresponding script identifier. The text DB stores X, Y coordinates (p_left, p_top) of the speech balloon that corresponds to each serial number (hwa_key_no).

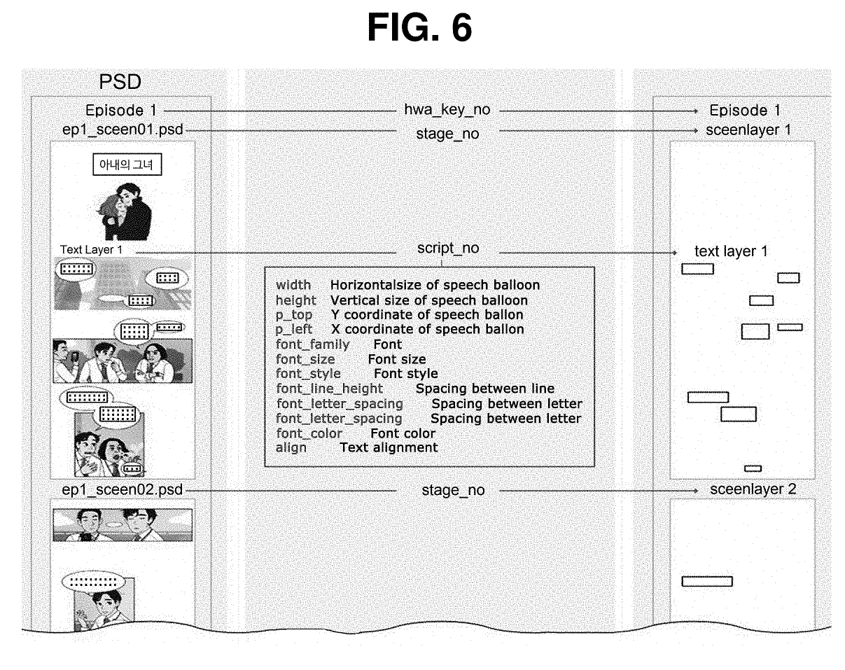

FIG. 6 is a view showing an example of an execution screen of a text transform UI where several PSD files of one episode are arranged in order and the text input window matched with the speech balloon in the text layer at the right side.

Translation

By using the text transform UI, detailed content e.g. an image, text, a speech balloon, etc. of the webcomic stored in the database is automatically shown at the left side of the translation tool in the same position as in the PSD file. Here, when directly translating the text through the text translation form at the right side, the translation is directly applied to a webcomic stage screen at the left side. Translation may be performed through machine translation or cloud translation by many people. Here, machine translation is performed based on the key value of text in the DB structure by exchanging translation information with machine translation search engine of a translation company through the API, and then a professional translator corrects the mistranslated text.

Next, the translated text is transformed by using the font color, the font type, the font size stored in the database, and stored as a text layer PSD file. When combining and uploading all PSD files, a translated webcomic can be provided.

The present invention may be implemented by a storage device (e.g. a memory, a compact disk) having a program for executing a series of steps of extracting and translating text as described above or by a computer device having the storage device.

Although the preferred embodiments of the present invention have been disclosed and illustrated using the specific terms, those skilled in the art will appreciate that such terms are merely used to clearly describe the present invention, and various modifications and variations of the embodiments of the present invention are possible, without departing from the scope and spirit of the invention as disclosed in the accompanying claims. Also, the present invention is intended to cover not only the embodiments, but also modifications and variations that may be included within the scope and spirit of the present invention as disclosed in the accompanying claims.

What is claimed is:

1. A method of extracting text in a text layer from a Photoshop file containing an image layer and the text layer, the method comprising:
uploading the Photoshop file at a first step;
parsing, at a second step, a layer and mask information section and parsing additional layer information of the layer and mask information section, reading a ‘Key’ having length of 4, and determining whether the ‘Key’ is composed of a ‘TySh’ tag; and
determining, at a third step, a relevant layer as the text layer when determining that the ‘Key’ is composed of the ‘TySh’ tag at the second step.

2. The method of claim 1, after the third step, further comprising: extracting, at a fourth step, the text in the text layer from a part where length is ‘Variable’ and description is ‘Text data’ by parsing type tool object setting when determining the relevant layer as the text layer at the third step.

3. A method of providing a translated webcomic by translating text of a text layer in an original language into another language, the webcomic containing one episode composed of several image layers and several text layers as scripts,
the method comprising:
uploading a Photoshop file at a first step;
parsing, at a second step, a layer and mask information section and parsing additional layer information of the layer and mask information section, reading a ‘Key’ having length of 4, and determining whether the ‘Key is composed of a ‘TySh’ tag;
determining, at a third step, a relevant layer as the text layer when determining that the ‘Key’ is composed of the ‘TySh’ tag at the second step and extracting the text in the text layer and a text attribute including a font color;
providing, at a fourth step, a translation tool showing both the text layer including the text in an original language and a text input window for inputting text to be translated;
performing, at a fifth step, machine translation of the text in the original language to provide the machine-translated text to the text input window, and receiving error corrections of the machine-translated text; and
transforming, at a sixth step, the text attributes of the machine-translated text at the fifth step to generate a Photoshop file, and providing a translated webcomic file by using the Photoshop file.

4. The method of claim 3, wherein at the third step, the text in the text layer is extracted from a part where length is ‘Variable’ and description is ‘Text data’ by parsing type tool object setting.

5. The method of claim 3, wherein at the fourth step, the text layer includes several speech balloons in addition to the text in the original language, and the text input window is matched with each of the speech balloons by using an episode identifier for distinguishing the episode, a script identifier for each of the scripts, and X, Y coordinates of each of the speech balloons in the scripts.

6. A computer device comprising a memory having a program for extracting text in a text layer from a Photoshop file containing an image layer and the text layer, the program executing a series of processes including: uploading the Photoshop file at a first step; parsing, at a second step, a layer and mask information section and parsing additional layer information of the layer and mask information section, reading a ‘Key having length of 4, and determining whether the ‘Key’ is composed of a ‘TySh’ tag; and determining, at a third step, a relevant layer as the text layer when determining that the ‘Key’ is composed of the ‘TySh’ tag at the second step.

7. The computer device of claim 6, wherein after the third step, the series of processes further includes: extracting, at a fourth step, the text in the text layer from a part where length is ‘Variable’ and description is ‘Text data’ by a parsing type tool object setting when determining the relevant layer as the text layer at the third step.
